(19) United States
(12) Patent Application Publication
(10) Pub. No.: US 2014/0274372 A1
(43) Pub. Date: Sep. 18, 2014

(54) TOUCH BUTTON WITH TACTILE ELEMENTS

(71) Applicant: IGT, Reno, NV (US)

(72) Inventor: Tai Rosander, Reno, NV (US)

(73) Assignee: IGT, Reno, NV (US)

(21) Appl. No.: 13/830,773

(22) Filed: Mar. 14, 2013

(51) Int. Cl. G07F 17/32

(52) U.S. Cl. CPC G07F 17/3209
USPC 463/31; 463/37

(57) ABSTRACT

An electronic gaming machine for playing an electronic game is disclosed. The gaming machine includes a cabinet, a game controller housed within the cabinet, a display configured to display the electronic game to a player, and a user-input panel. The gaming machine further includes a first button mounted to the user-input panel. The first button includes a first touch sensing section configured to receive inputs from a player and to provide signals relating to the inputs to the game controller. The gaming machine further includes a first tactile element. The first tactile element is distinguishable from the first touch sensing section by the player by sense of touch.

### BACKGROUND OF THE INVENTION

Many of today's casinos and other entertainment locations feature different single and multi-player gaming systems such as slot machines, video poker machines, and bar top electronic gaming machines. The gaming machines may include a number of hardware and software components to provide a wide variety of game types and game playing capabilities. Exemplary hardware components may include bill validators, coin acceptors, card readers, keypads, mechanical buttons, levers, touch screens, coin hoppers, ticket printers, player tracking units and the like. Software components may include, for example, boot and initialization routines, various game play programs and subroutines, credit and payout routines, image and audio generation programs, various component modules and a random or pseudo-random number generator, among others.

Gaming machines are highly regulated to ensure fairness. In many cases, gaming machines may be operable to dispense monetary awards of a large amount of money. Accordingly, access to gaming machines is often carefully controlled. For example, in some jurisdictions, routine maintenance requires that extra personnel (e.g., gaming control personnel) be notified in advance and be in attendance during such maintenance. Additionally, gaming machines may have hardware and software architectures that differ significantly from those of general-purpose computers (PCs), even though both gaming machines and PCs employ microprocessors to control a variety of devices. For example, gaming machines may have more stringent security requirements and fault tolerance requirements. Additionally, gaming machines generally operate in harsher environments as compared with PCs.

Gaming machines typically have input devices, such as mechanical push-buttons, to receive player inputs, e.g., to place a wager. These input devices are critical to enable the typical game play rhythm of repeat use initiating the start of a game for a slot type product or the constant interaction of several buttons for a poker type product. A gaming machine with such devices may be susceptible to foreign contaminates getting into the machine and interfering with the proper operation of the gaming machine. For example, a player may spill liquids containing alcohol, sugar, etc. on the panel of the gaming machine, which may then enter the input device and cause the input device to stop working. An input device on an angled panel or a bar top gaming machine may be more susceptible to contamination due to its relative location and/or the accessibility of drinking containers to the player and the input device(s).

The input device of the gaming machine may have a reduced tactile function and/or function. For example, the input device may become inoperable when the foreign contaminate enters the housing or other components of the input device. The foreign contaminates may affect internal electrical connections of the button and may cause the moving parts of the button to stick. In such situations, the faulty input device is typically replaced by the casino operator. Modern input devices which include LCD or similar displays can be relatively expensive to replace. Besides the costs incurred by replacing a faulty input device, the game machine operator also suffers a decline in income while the gaming machine is inoperable.

As with any input device, player comfort during use is desired to avoid fatigue during extended periods of interaction. The ability to avoid excess activation force or a lack of resting ones hand and/or fingers on the input device provides the player less discomfort during a gaming session.

The use of touch sensing buttons instead of mechanical push-buttons can help reduce foreign contaminate access to internal compartments of the gaming machine. Touch sensing buttons, such as capacitive touch sensors, are less vulnerable to spilled liquids. Generally, touch sensing buttons do not have moving parts and are relatively easy to seal off such that spilled liquids cannot penetrate into internal compartments of the gaming machines. It is desirable to provide comfort and reduce fatigue during game play by enabling the right amount of sensitivity and prevent the player from having to hover over the input device to avoid an unwanted activation during game play.

### SUMMARY OF THE INVENTION

According to various examples, an electronic gaming machine for playing an electronic game is disclosed. The gaming machine includes a cabinet, a game controller housed within the cabinet, a display configured to display the electronic game to a player, and a user-input panel. The gaming machine further includes a first button mounted to the user-input panel. The first button includes a first touch sensing section configured to receive inputs from a player and to provide signals relating to the inputs to the game controller. The gaming machine further includes a first tactile element. The first tactile element is distinguishable from the first touch sensing section by the player by sense of touch.

According to one example implementation, an electronic gaming machine for playing an electronic game is disclosed. The electronic gaming machine includes a cabinet and a game controller housed within the cabinet. The electronic gaming machine further includes a display configured to display the electronic game to a player. The electronic gaming machine includes a user-input panel. The electronic gaming machine further includes a first button embedded in the user-input panel such that the first button is substantially flush with a surface of the user-input panel. The first button includes a first touch sensing section configured to receive inputs from the player and to provide signals relating to the inputs to the game controller. The electronic gaming machine includes a first tactile element positioned adjacent the first button. The first tactile element is textured with a first raised component such that a surface of the first tactile element has a different texture than a surface of the user-input panel and a surface of the first touch sensing section.

According to another example implementation, a button assembly is disclosed. The button assembly includes a touch sensitive portion including a touch sensor. The touch sensitive portion is configured to receive inputs from a player and output a signals relating to the inputs. The button assembly further includes a tactile portion at least partially surrounding the touch sensitive portion. The tactile portion is textured with a raised element such that a surface of the tactile portion has a different texture than a surface of the touch sensitive portion. The button assembly further includes a seal. The button assembly is configured to be mounted into a panel such that the seal prevents foreign contaminants from accessing underneath the button assembly or inside the panel.

### BRIEF DESCRIPTION OF THE DRAWINGS

The details of one or more implementations are set forth in the accompanying drawings and the description below. Other features, aspects, and advantages of the disclosure will become apparent from the descriptions, the drawings, and the claims, in which:

FIG. 1 is a perspective view of a gaming machine according to an exemplary embodiment.

FIG. 2 is an illustration of button assembly according to an exemplary embodiment.

FIG. 3 is a side view of the button assembly of FIG. 2.

FIG. is an illustration of button assembly according to an exemplary embodiment.

FIG. 5 is an illustration of a user input panel according to an exemplary embodiment.

FIG. 6 is a perspective view of a gaming machine according to an exemplary embodiment.

FIG. 7 is an illustration of a user input panel according to an exemplary embodiment.

### DETAILED DESCRIPTION OF THE PREFERRED EMBODIMENTS

Numerous specific details may be set forth below to provide a thorough understanding of concepts underlying the described implementations. It may be apparent, however, to one skilled in the art that the described implementations may be practiced without some or all of these specific details. In other instances, some process steps have not been described in detail in order to avoid unnecessarily obscuring the underlying concept.

Referring generally to the figures, a gaming machine, input device and components thereof are shown according to described implementations. Before discussing further details of the gaming device, the input device and/or the components thereof, it should be noted that references to “front,” “back,” “rear,” “upward,” “downward,” “inner,” “outer,” “right,” and “left” in this description are merely used to identify the various elements as they are oriented in the Figures. These terms are not meant to limit the element which they describe, as the various elements may be oriented differently in various applications.

It should further be noted that for purposes of this disclosure, the term “couple” means the joining of two members directly or indirectly to one another. Such joining may be stationary in nature or moveable in nature and/or such joining may allow for the flow of fluids, electricity, electrical signals, or other types of signals or communication between the two members. Such joining may be achieved with the two members or the two members and any additional intermediate members being integrally formed as a single unitary body with one another or with the two members or the two members and any additional intermediate members being attached to one another. Such joining may be permanent in nature or, alternatively, may be removable or releasable in nature.

Referring to FIG. 1, a perspective drawing of an electronic gaming machine 102 is shown in accordance with described implementations. Gaming machine 102 may include a main cabinet 104. Main cabinet 104 may provide a secure enclosure that prevents tampering with device components, such as a game controller and a coin hopper (not shown) located within the interior of main cabinet 104. Main cabinet 104 may include an access mechanism, such as a door 106, which allows the interior of gaming machine 102 to be accessed. Actuation of a door 106 may be controlled by a locking mechanism 114. In some implementations, locking mechanism 114, door 106, and the interior of main cabinet 104 may be monitored with security sensors of various types to detect whether the interior has been accessed. For instance, a light sensor may be provided within main cabinet 104 to detect a change in light-levels when door 106 is opened and/or an accelerometer may be attached to door 106 to detect when door 106 is opened.

Gaming machine 102 may include any number of user interface devices that convey sensory information to a user and/or receive input from the user. For example, gaming machine 102 may include a first electronic display 110, a second electronic display 122, speakers 126, and/or a candle device 112 to convey information to the user of gaming machine 102. Gaming machine 102 may also include a panel 124 having one or more input devices 134 (e.g., buttons, track pads, etc.) configured to receive input from a user. Input devices 134 may be mounted to panel 124. Input devices 134 are raised from panel 124. Alternatively, input devices 134 are mounted flush with panel 124 or are recessed with respect to a top surface of panel 124.

In one implementation, display 110 and/or display 122 may also be a touch screen displays configured to receive input from a user. A gaming controller (not shown) within gaming machine 102 may run a game, such as a wager-based game, in response to receiving input from a user via input devices 134 or display 110. For example, input devices 134 may be operated to place a wager in the game and to run the game. In response, the gaming controller may cause second electronic display 122, which may include electro-mechanical reels, to spin, such as with a slot game, and/or display 110 to display the results of the game.

Gaming machine 102 may also include devices for conducting a wager-based game. For example, gaming machine 102 may include a coin acceptor 132, a printer 120, a bill acceptor 116, and a coin tray 136. Gaming machine 102 may receive physical money and/or tokens via coin acceptor 132 and bill acceptor 116 and dispense physical money or tokens via coin tray 136. Gaming machine 102 may convert received money or tokens into game credits, which may be used within the gaming establishment in lieu of money. In some cases, gaming machine 102 may also receive and dispense credits. For example, printer 120 may print a ticket for larger payouts that can be redeemed for physical money. In some cases, bill acceptor 116 may be configured to redeem a payout ticket in the form of game credits. Such a configuration may allow a user to transfer credits between gaming machines. According to various implementations, gaming machine 102 may record data regarding its receipt and/or disbursement of money or credit. Gaming machine 102 may provide such accounting data to a remote repository.

The input devices 134 are exemplified by button assembly 200 shown in FIG. 2. Button assembly 200 includes touch sensitive portion 201. Button assembly 200 provides signals corresponding to user inputs to a game controller (e.g., a game controller of gaming machine 102). Touch sensitive portion 201 is configured to receive inputs associated with the playing of the electronic game from a player through the use of a touch detecting sensor. Touch sensitive portion 201 may include a capacitive touch sensor, a resistive touch sensor, or a piezo touch sensor configured to detect an input from the player. Other touch sensing sensor technologies may also be used. By utilizing a touch sensor, button assembly 200 does not require a user to place a substantial activation force (i.e., a force that is perceptible to the player) against a moving mechanical button (e.g., the pressing of a spring loaded mechanical button) to register a user input. Instead, a player of the electronic game provides input through input device by touching touch sensitive portion 201. With the exception of any minimal displacement needed to activate a resistive touch sensor or a piezo touch sensor, button assembly 200 utilizes no moving parts in detecting a user input. Touch sensitive portion 201 may be clear or semi-transparent. Alternatively, touch sensitive portion 201 may be colored. A label (shown as “DEAL|DRAW”), may be removably placed behind touch sensitive portion 201 such that the label is visible to the player through touch sensitive portion 201. Touch sensitive portion 201 may be backlit by an appropriate backlighting source (e.g., an LED, an incandescent bulb, etc.). The backlighting source may be selectively activated and deactivated by the game controller. Further, the backlighting source may have its emitted color adjusted by the game controller.

Touch sensitive portion 201 is at least partially surrounded by tactile portion 202. Tactile portion 202 is not touch sensitive. If a user touches tactile portion 202, button assembly 200 does not register a user touch or a user input and a signal is not sent to the game controller. Tactile portion 202 may be positioned on any side of touch sensitive portion 201 such that tactile portion 202 at least partially surrounds touch sensitive portion 201. Tactile portion 202 may completely surround touch sensitive portion 201. Tactile portion 202 is textured via raised elements 203 that are coupled to the tactile portion 202. Raised elements 201 are protrusions extending from a generally smooth surface of tactile portion 202. Accordingly, tactile portion 202 is distinguishable via touch from a generally smooth surface, such as the surface of button panel 124 or the surface of touch sensitive portion 201. Raised elements 203 are arranged to provide a player of the electronic gaming machine a tactile indication that the player's finger is close to touch sensitive portion 201 of button assembly 200 when the finger is resting on raised elements 203. Thus, tactile portion 202 provides a user with a tactile reference to distinguish between touch sensitive area 201 and a non-touch sensitive area of the gaming machine to reduce accidental activation of touch sensitive portion 201. Tactile portion 202 serves as a stop to prevent accidental user inputs on touch sensitive portion 201. For example, a player may wish to keep his eyes focused on the display during game play of the gaming machine and locate touch sensitive portion by feel. Raised elements 203 can be raised lines, raised shapes (e.g., circles, squares, triangles, etc.), raised dots, or a combination thereof. Tactile portion 202 may be removable and repositionable or replaceable (i.e., such that the orientation can change from the bottom to either side or the top). In an alternative arrangement, tactile portion 202 is textured with depressions instead of protrusions (e.g., lowered elements extending below a generally smooth surface of tactile portion 202 that are sensible by a user's sense of touch). In yet another alternative, tactile portion 202 has the same texture as touch sensitive portion 201, but tactile portion 202 is distinguishable from touch sensitive portion 201 by the player's sense of touch because of a different perceived feel to the player (e.g., tactile portion is hot, while touch sensitive portion is cold; tactile portion is soft, while touch sensitive portion is hard; etc.).

Tactile portion 202 may be able to change shape. In other words, the location, arrangement, and shape of raised elements 203 (or depressed elements) can be modified by a game controller. Tactile portion 202 may be constructed out of a material capable of morphing shape such that individual raised elements 203 can be removed (i.e., lowered to become flush with the top surface of tactile portion 202), new elements can be raised (i.e., an area of tactile portion 202 that is normally flush with the top surface of tactile portion 202 rises to give a textured feel), and/or raised elements may shift shape (e.g., change shape from a raised dot to a raised line).

In an alternative arrangement, tactile portion 202 is touch sensitive and may be configured to register a user input that does not correspond to a user input achieved by touching touch sensitive portion 201. In such an alternative arrangement, tactile portion 202 also includes a capacitive touch sensor, a resistive touch sensor, a piezo touch sensor, or another touch sensing sensor configured to detect an input from the player. When a user contacts tactile portion 202, a user input is detected and sent to a controller of the gaming machine. The gaming machine may then indicate to the user that the user's finger is in close proximity to touch sensitive portion 201. For example, if the gaming machine is a shooting game, a user input registered on touch sensitive portion 201 may cause a gun to be fired in the electronic game played on the gaming machine, while a user input registered on tactile portion 202 may cause the game to emit a sound corresponding to a gun cocking or display an indication that the user's finger is close to touch sensitive portion 201 (e.g., by displaying “Safety Off”′).

In an alternate arrangement, touch sensitive portion 201 includes a display. In such an arrangement, button assembly 200 does not include a removably placed label (as discussed above). The display may be an LCD, OLED, TFT, or any other suitable display technology. The display is in direct or indirect communication with the gaming controller, such as to receive display content. The display may include a separate controller and memory configured to render or to assist in the rendering of displayed images and, animations, and videos. The display can be used to selectively display a static image, displayed text (e.g., imitating a paper label displaying “DEAL|DRAW”), a color, or an animation. The output of the display can vary throughout play of the game on a gaming machine. For example, during a first stage of game play, a button may display a first image, and during a second stage of game play, the button may display a second image.

Button assembly 200 may include a haptic feedback mechanism. The haptic feedback mechanism may be configured to provide a vibration upon detecting an input received through touch sensitive portion 201. The haptic feedback mechanism may be a vibratory motor or any other mechanism operable to provide a vibration sensation to a user in contact with touch sensitive portion 201. The magnitude and duration of the vibration are controllable by the game controller. For example, a short vibration may be used if a quick tap by a player is recognized at touch sensitive portion 201. If a long press by a player is recognized at touch sensitive portion 201 (e.g., a player maintains contact with touch sensitive portion 201 for an extended duration), a long vibration matching the duration of the touch may be used.

Referring to FIG. 3, a side view of button assembly 200 mounted on panel 124 is shown. Button assembly 200 may be mounted on panel 124 such that button assembly 200 is raised above the surface of panel 124. Seal mechanism 204 is positioned between button assembly 200 and panel 124. Seal mechanism 204 is configured to prevent spilled liquids and foreign contaminants from seeping underneath button assembly 200 and into an interior compartment of panel 124 (e.g., the compartment containing necessary wiring for button assembly 200). Seal mechanism 204 may be a membrane, a gasket, or a sealant.

A player of a game on a gaming machine that incorporates button assembly 200 may choose to utilize tactile portion 202 advantageously during gameplay. For example, the player may rest his finger on tactile portion 202 and later slide the pad of his finger onto touch sensitive portion 201 to register a button activation. In doing so, the player may retain a portion of his finger in contact with tactile portion 202 to quickly withdraw the finger from touch sensitive portion 201 after perceiving the intentional contact with touch sensitive portion 201. Such a quick, no-look activation of touch sensitive area 201 may assist a player in timed gameplay where the player may not wish to take his eyes off of the main game display, but still quickly activate game inputs (e.g., activating the “Hold” or “Deal” button during gameplay of video poker). In yet another example, the player may keep a first finger pressed on tactile portion 202 to locate touch sensitive portion 201 and activate touch sensitive portion 201 with a second finger while keeping the first finger on tactile portion 202.

The input devices 134 are additionally exemplified by button 400 shown in FIG. 4. Button 400 is similar to button assembly 200. Button 400 includes touch sensitive portion 401. Button 400 provides signals corresponding to user inputs to a game controller (e.g., a game controller of gaming machine 102). Touch sensitive portion 401 is configured to receive inputs associated with the playing of the electronic game from a player through the use of a touch detecting sensor. Touch sensitive portion 401 may include a capacitive touch sensor, a resistive touch sensor, or a piezo touch sensor. Other touch sensing input technologies may also be used. A player of the electronic game provides input through input device by touching touch sensitive portion 401. By utilizing a touch sensor, button 400 does not require a the user to place a substantial activation force against a moving mechanical button (e.g., the pressing of a spring loaded mechanical button) to register a user input. Instead, a player of the electronic game provides input through input device by touching touch sensitive portion 401. With the exception of any minimal displacement needed to activate a resistive touch sensor or a piezo touch sensor, button 400 utilizes no moving parts in detecting a user input. Touch sensitive portion 401 may be clear or semi-transparent. Alternatively, touch sensitive portion 401 may be colored. A label (shown as “DEAL|DRAW”), may be removably placed behind touch sensitive portion 401 such that the label may be visible to the player through touch sensitive portion 401. Touch sensitive portion 401 may be backlit by an appropriate backlighting source (e.g., an LED, an incandescent bulb, etc.). The backlighting source may be selectively activated and deactivated by the game controller. Further, the backlighting source may have its emitted color adjusted by the game controller.

Touch sensitive portion 401 is fully surrounded by tactile portion 402. Tactile portion 402 is not touch sensitive. Tactile portion 402 is not touch sensitive. If a user touches tactile portion 402, button assembly 400 does not register a user touch or a user input and a signal is not sent to the game controller. Tactile portion 402 may be positioned on any side of touch sensitive portion 401 such that tactile portion 402 at least partially surrounds touch sensitive portion 401. Tactile portion 402 may completely surround touch sensitive portion 401. Tactile portion 402 is textured via raised elements 403 that are coupled to the tactile portion 402. Raised elements 401 are protrusions extending from a generally smooth surface of tactile portion 402. Accordingly, tactile portion 402 is distinguishable via touch from a generally smooth surface, such as the surface of button panel 124 or the surface of touch sensitive portion 401. Raised elements 403 are arranged to provide a player of the electronic gaming machine a tactile indication that the player's finger is close to touch sensitive portion 401 of button assembly 400 when the finger is resting on raised elements 403. Thus, tactile portion 402 provides a user a way of quickly locating touch sensitive portion 401 without accidentally activating touch sensitive portion 401. Tactile portion 402 serves as a stop to prevent accidental user inputs on touch sensitive portion 401. For example, a player may wish to keep his eyes focused on the display during game play of the gaming machine and locate touch sensitive portion by feel. Raised elements 403 can be raised lines, raised shapes (e.g., circles, squares, triangles, etc.), raised dots, or a combination thereof. Tactile portion 402 may be removable and repositionable or replaceable (i.e., such that the orientation can change from the bottom to either side or the top). In an alternative arrangement, tactile portion 402 is textured with depressions instead of protrusions (e.g., lowered elements extending below a generally smooth surface of tactile portion 402 that are sensible by a user's sense of touch).

In an alternative arrangement, tactile portion 402 is configured to partially cover touch sensitive portion 401. In such an alternative arrangement, tactile portion 402 may be raised above the top surface of touch sensitive portion 401, and a depression in tactile portion 402 exposes a portion of the top surface of touch sensitive portion 401. The depression may be approximately shaped and sized to accommodate the pad of a player's finger, such that when a finger is placed in the depression, the pad of the finger makes contact with touch sensitive portion 401. Accordingly, during use, the player may rest his finger on tactile portion 402 and slide the pad of his finger into the depression in tactile portion 402 to make contact with touch sensitive portion 401.

In another alternative arrangement, tactile portion 402 is touch sensitive and may be configured to register a user input that does not correspond to a user input achieved by touching touch sensitive portion 401. In such an alternative arrangement, tactile portion 402 also includes a capacitive touch sensor, a resistive touch sensor, a piezo touch sensor, or another touch sensing sensor configured to detect an input from the player. When a user contacts tactile portion 402, a user input is detected and sent to a controller of the gaming machine. The gaming machine may then indicate to the user that the user's finger is in close proximity to touch sensitive portion 401. For example, if the gaming machine is a shooting game, a user input registered on touch sensitive portion 401 may cause a gun to be fired in the electronic game played on the gaming machine, while a user input registered on tactile portion 402 may cause the game to emit a sound corresponding to a gun cocking or display an indication that the user's finger is close to touch sensitive portion 401 (e.g., by displaying “Safety Off”′).

Button 400 may additionally include a display and/or a haptic feedback mechanism as discussed above with respect to button assembly 200.

Referring to FIG. 5, a user input arrangement of panel 124 is shown according to an exemplary embodiment. Panel 124 includes a plurality of buttons (e.g., 200 and 400). Each button includes a tactile portion having raised elements (e.g., 203a, 203b, and 403). The tactile portions may partially surround touch sensitive portions of the user inputs or completely surround the touch sensitive portions. The raised elements have the same or differing arrangements and combinations of raised lines, raised shapes (e.g., circles, squares, triangles, etc.), raised dots, or a combination thereof such that each tactile portion has a different texture from a surface of the panel and a surface of the touch sensitive portions. Further, the raised elements may be arranged such that each tactile element has the same or differing surface textures than other tactile elements. For example, a first user input has a first tactile portion that partially surrounds a first touch sensitive portion, the first tactile portion includes a series of raised lines (e.g., 203a); a second user input has a second tactile portion that partially surrounds a second touch sensitive portion, the second tactile portion includes a series of raised dots (e.g., 203b); and a third user input has a third tactile element that completely surrounds a touch sensitive portion, the third tactile portion includes a series of raised lines (e.g., 403). The differing tactile portion arrangements can be used to designate specific game commands (e.g., raised dots may designate a “hold” function in a video poker game, while raised lines may designate a “bet” function of the game). Panel 124 is shown as including seven user inputs. However, panel 124 can also be configured to include more or less than seven buttons.

Referring to FIG. 6, a gaming machine 600 is shown according to an exemplary embodiment. Gaming machine 600 is substantially similar to gaming machine 102. The primary difference between gaming machine 600 and gaming machine 102 is found in the layout of panel 602. Panel 602 includes buttons 603. Buttons 603 are embedded in the surface of panel 602. Accordingly, the top surfaces of buttons 603 are substantially flush with the top surface of panel 602. Buttons 603 are configured to receive player inputs associated with the playing of an electronic game from a player. Each button 603 includes a touch sensitive portion, which may be a capacitive touch sensor, a resistive touch sensor, or a piezo touch sensor. Other touch sensing input technologies may also be used. A player of the electronic game provides input through input device by touching the touch sensitive portion. Buttons 603 are similar in construction and function as button assembly 200.

Panel 602 includes tactile portions 604. Tactile portions 604 are positioned adjacent to buttons 603. Tactile portions 604 are embedded in or formed as part of panel 602. Alternatively, tactile portions 604 are removable inserts that are received into sockets built into panel 602 such that tactile portions can be replaced and repositioned. Tactile portions 604 may partially surround or completely surround individual buttons 603. Alternatively, tactile portions 604 may partially surround or completely surround multiple user interfaces (e.g., a single set of raised ribs can extend across multiple buttons 603). In such an alternative arrangement, tactile portions 604 may extend across multiple buttons 603 (e.g., a series of raised ribs or lines extending across at least two buttons 603). Tactile portions 604 are not touch-sensitive such that when a player touches tactile portions 604, player inputs are not registered by the game controller of gaming machine 600. Tactile portions 604 include raised elements. The raised elements are arranged to provide a player of the electronic gaming machine an indication that the player's finger is close to a button 603 when the finger is resting on a tactile portion 604. Alternatively, the raised elements are positioned such that they provide tactile feedback to a player's wrists. The raised elements can be raised lines, raised shapes (e.g., circles, squares, triangles, etc.), raised dots, or a combination thereof.

Referring to FIG. 7, a user input arrangement of panel 124 of an electronic gaming machine is shown according to an exemplary embodiment. Panel 124 includes a single touchscreen 701. Touchscreen 701 may be embedded in panel 124 such that the top surface of touchscreen 701 is substantially flush with the top surface of panel 124. Alternatively, the top surface of touchscreen 701 is not substantially flush with the top surface of panel 124. Touchscreen 701 displays at least one user interaction zone 702. Each user interaction zone 702 corresponds to a function of a game. Accordingly, when a user interacts with a first user interaction zone (e.g., a zone displaying the word “BET”) a first signal is sent to the game controller corresponding to a first game function (e.g., placing a bet), and when a user interacts with a second user interaction zone (e.g., a zone displaying the word “HOLD”), a second signal is sent to the game controller corresponding to a second game function (e.g., holding a card during a deal).

Touchscreen 701 is surrounded by tactile portion 703. Tactile portion 703 is shown as completely surrounding touchscreen 701. Alternatively, tactile portion 703 partially surrounds touchscreen 701 (e.g., such that tactile portion is only present along one side of touchscreen 701). Tactile portion 703 includes raised elements 704. Raised elements 704 are placed such that a player of the game can rest his fingers in proximity to a user interaction zone 702 of touchscreen 701 without triggering an input to a controller of the electronic gaming machine. Each set of raised elements 704 may be individually aligned with and correspond to a single user interaction zone 702 or may span across multiple user interaction zones 702. Each set of raised elements 704 may have the same or differing arrangements and combinations of raised lines, raised shapes (e.g., circles, squares, triangles, etc.), raised dots, or a combination thereof. Accordingly, each set of raised elements 702 has a surface texture that is different than the substantially smooth texture of the top surface of panel 124 and of the substantially smooth top surface of touchscreen 701. A first set of raised elements 704 may have a different surface texture than a second set of raised elements 704. The differing tactile portion arrangements can be used to designate specific game commands (e.g., raised dots may designate a “hold” function in a video poker game, while raised lines may designate a “bet” function of the game). Panel 124 is shown as including seven user input zones 702, however, touchscreen 701 can be configured and reconfigured with any number of user input zones. Additionally, tactile portion 703 may be removed from panel 124 and replaced with an alternate tactile portion having a different arrangement of raised elements (e.g., corresponding to a different number of buttons or having different patterns of raised elements).

The construction and arrangement of the elements of the figures as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. The elements and assemblies may be constructed from any of a wide variety of materials that provide sufficient strength or durability, in any of a wide variety of colors, textures, and combinations. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the subject matter have been described. Other implementations are within the scope of the following claims.

What is claimed is:

1. An electronic gaming machine for playing an electronic game comprising:
a cabinet;
a game controller housed within the cabinet;
a display configured to display the electronic game to a player;
a user-input panel;
a first button mounted to the user-input panel, wherein the first button includes a first touch sensing section configured to receive inputs from a player and to provide signals relating to the inputs to the game controller; and
a first tactile element, wherein the first tactile element is distinguishable from the first touch sensing section by the player by sense of touch.

2. The electronic gaming machine of claim 1, wherein the first tactile element is textured such that a surface of the first tactile element has a different texture than a surface of the user-input panel and a surface of the first touch sensing section.

3. The electronic gaming machine of claim 2, wherein the first tactile element is textured with a first raised component is a raised line or a raised dot.

4. The electronic gaming machine of claim 1, wherein the first tactile element is non-touch sensing such that a signal is not sent to the game controller if the first tactile element is touched by the player.

5. The electronic gaming machine of claim 1, further comprising a seal positioned between the first button and the user-input panel, the seal configured to prevent foreign contaminants from accessing underneath the first button or inside the user-input panel.

6. The electronic gaming machine of claim 1, wherein the first tactile element is adjacent the first touch sensing section.

7. The electronic gaming machine of claim 1, wherein the first tactile element completely surrounds the first touch sensing section.

8. The electronic gaming machine of claim 1, further comprising a second button mounted to the user-input panel, wherein the second button includes a second touch sensing section configured to receive inputs from the player and to provide signals relating to the inputs to the game controller, and a second tactile element, wherein the second tactile element is textured such that a surface of the second tactile element has a different texture than a surface of the user-input panel and a surface of the second touch sensing section.

9. The electronic gaming machine of claim 8, wherein the surface of the second tactile element has a different texture than a surface of the first tactile element.

10. The electronic gaming machine of claim 8, wherein the second tactile element is non-touch sensing such that a signal is not sent to the game controller when the second tactile element is touched by the player.

11. The electronic gaming machine of claim 1, wherein the first button is not flush with a surface of the user-input panel.

12. An electronic gaming machine for playing an electronic game comprising:
a cabinet;
a game controller housed within the cabinet;
a display configured to display the electronic game to a player;
a user-input panel; and
a first button embedded in the user-input panel such that the first button is substantially flush with a surface of the user-input panel, wherein the first button includes a first touch sensing section configured to receive inputs from the player and to provide signals relating to the inputs to the game controller; and
a first tactile element positioned adjacent the first button, wherein the first tactile element is textured with a first raised component such that a surface of the first tactile element has a different texture than a surface of the user-input panel and a surface of the first touch sensing section.

13. The electronic gaming machine of claim 12, wherein the first tactile is non-touch sensing such that a signal is not sent to the game controller if the first tactile element is touched by the player.

14. The electronic gaming machine of claim 12, wherein the first tactile element is removably placed in a socket of the user-input panel.

15. The electronic gaming machine of claim 12, wherein the first touch sensing section is a touchscreen configured to display a first user interaction zone corresponding to a first game function and a second user interaction zone corresponding to a second game function, wherein when the player contacts the first user interaction zone, a first signal sent to the game controller corresponding to a first game function, and wherein when the player contacts the second user interaction zone, a second signal is sent to the game controller corresponding to a second game function.

16. The electronic gaming machine of claim 12, further comprising a second tactile element with a second raised component such that a surface of the second tactile element has a different texture than the surface of the user-input panel and the surface of the first touch sensing section; wherein the first tactile element is aligned with and corresponds to the first user interaction zone and the second tactile element is aligned with and corresponds to the second user interaction zone.

17. The electronic gaming machine of claim 12, wherein the raised component is a raised line or a raised dot.

18. The electronic gaming machine of claim 12, wherein the first tactile element completely surrounds the first touch sensing section.

19. The electronic gaming machine of claim 12, further comprising a second button embedded in the user-input panel such that the second button is substantially flush with the surface of the user-input panel, wherein the first button includes a second touch sensing section configured to receive inputs from the player and to provide signals relating to the inputs to the game controller.

20. The electronic gaming machine of claim 19, further comprising a second tactile element positioned adjacent the second button, wherein the second tactile element is textured with a second raised component such that a surface of the second tactile element has a different texture than the surface of the user-input panel and a surface of the second touch sensing section.

21. The electronic gaming machine of claim 19, wherein the first tactile element is adjacent to the first button and the second button, and wherein the first tactile element extends across an area of the first button and the second button on the user-input panel such that the first tactile element partially surrounds the first button and the second button.

22. A button assembly comprising:
a touch sensitive portion including a touch sensor, wherein the touch sensitive portion is configured to receive inputs from a player and output a signals relating to the inputs;
a tactile portion at least partially surrounding the touch sensitive portion, wherein the tactile portion is textured with a raised element such that a surface of the tactile portion has a different texture than a surface of the touch sensitive portion;
a seal;
wherein the button assembly is configured to be mounted into a panel such that the seal prevents foreign contaminants from accessing underneath the button assembly or inside the panel.

23. The button assembly of claim 22, further comprising a haptic feedback mechanism configured to vibrate upon a detection of a user input at the touch sensitive portion.

24. The button assembly of claim 22, wherein the touch sensitive portion includes a display configured to selectively display an image, a color, or an animation.

25. The button assembly of claim 24, further comprising a display controller configured to render the image, the color, or the animation.

26. The button assembly of claim 22, wherein the raised element is a raised line or a raised dot.

27. The button assembly of claim 22, wherein the tactile portion is non-touch sensing such that a signal is not sent if the first tactile element is touched by the player.

28. The button assembly of claim 22, wherein the tactile portion completely surrounds the touch sensitive portion.
